(19) United States
(12) Patent Application Publication
(10) Pub. No.: US 2026/0369917 A1
(43) Pub. Date: Nov. 19, 2026

(54) MOVABLE CONNECTOR HOUSING, HOUSING ASSEMBLY, CONTACT ASSEMBLY AND PLUG CONNECTION

(71) Applicant: TE Connectivity Solutions GmbH, Schaffhausen (CH)

(72) Inventor: Markus ECKEL, Schaffhausen (CH)

(21) Appl. No.: 19/407,098

(22) Filed: Dec. 3, 2025

(30) Foreign Application Priority Data
Dec. 5, 2024 (DE) 102024136347.9

(51) Int. Cl. H01R 13/502

(52) U.S. Cl. CPC H01R 13/502

(57) ABSTRACT

A connector housing with a first and a second housing section, with a receptacle extending from a first access opening to a second access opening, in which at least one busbar and/or contact structure can be accommodated at least in sections, wherein the first access opening is arranged in the first housing section and the second access opening is arranged in the second housing section, wherein the first housing section is movable relative to the second housing section. Such a connector housing is suitable for tolerance-compensating plug connections.

### CROSS REFERENCE TO RELATED APPLICATIONS

This application claims the benefit of DE Application No. 102024136347.9, filed 05-Dec. 2024, the subject matter of which is herein incorporated by reference in its entirety.

### BACKGROUND OF THE INVENTION

The subject matter herein relates to a connector housing, a housing assembly with such connector housings, and a contact assembly with such a contact arrangement. The subject matter herein also relates to a plug connection with such a contact assembly.

Electrical plug connections often have electrical conductors, such as busbars, which can be electrically connected to each other via a contact structure. Particularly in areas of application where the busbars are subject to movement, for example due to vibrations or changes in position, the contact structure must sometimes compensate for large tolerances between the busbars. In addition, plug connections usually require a housing to protect the current-carrying components. The housing must not block the tolerance-compensating movements of the contact structure and the busbars.

There is a need for a tolerance-compensating electrical plug connection and its parts.

### BRIEF DESCRIPTION OF THE INVENTION

In one embodiment, a connector housing is provided including a first and a second housing section with a receptacle extending from a first access opening to a second access opening, wherein in the receptacle at least one busbar and/or contact structure can be accommodated at least in sections, wherein the first access opening is arranged in the first housing section and the second access opening is arranged in the second housing section, and wherein the first housing section is movable relative to the second housing section.

The first and second housing sections of the connector housing are movable relative to each other. This means that an element connected to or arranged in the first housing section is also movable relative to an element connected to or arranged in the second housing section. The connector housing is therefore suitable for accommodating elements that are movable relative to each other in order to compensate for tolerances. By way of example, one element may correspond to a busbar and the other element to a contact structure. The mobility of the housing sections of the connector housing enables the tolerance-compensating movements of the elements relative to each other.

The subject matter herein can be further improved by the following features, each of which is advantageous in itself and can be combined with each other as desired.

The first housing section can be movable in translation and/or rotation relative to the second housing section. In particular, the first housing section can be movable in translation, in particular displaceable, relative to the second housing section along a first axis and/or second axis and/or third axis. The first, second and third axes may each extend perpendicular to each other. Alternatively or cumulatively, the first housing section may be rotatable, in particular pivotable, relative to the second housing section about the first and/or second and/or third axis.

In one embodiment, translational and rotational relative mobility between the first and second housing sections may be coupled.

The first and second housing sections can form a joint, for example a hinge or ball joint. For this purpose, the first and second housing sections can each have at least one joint section, in particular a joint surface, wherein the joint sections or joint surfaces are designed to be complementary to each other.

In order to ensure mobility in a low-wear manner, the first and second housing sections can together form a bearing, for example a roller bearing or plain bearing. For this purpose, the first and second housing sections can each have bearing sections designed to complement each other, for example bearing surfaces.

The connector housing may be accessible via the first and/or second access opening for the busbar and/or for the contact structure.

In order to securely and releasably connect the first housing section to the second housing section, the connector housing may have a form-fit assembly by means of which the first and second housing sections can be connected in a form-fitting manner. The first and second housing sections may each have at least one form-fit element, wherein the at least one form-fit element of the first housing section can be connected to the at least one form-fit element of the second housing section.

At least one form-fit element may be designed as a locking means by means of which the first housing section can be locked or is locked to the second housing section. Preferably, the locking is releasable and can be reattached.

The first housing section may have at least one locking projection and the second housing section may have at least one recess complementary to the at least one locking projection, wherein the at least one locking projection can be connected to the at least one recess in a form-fitting manner. For example, a locking hook may be provided as a locking projection and a groove may be provided as a recess.

In order to make the connector housing flexible and thus particularly suitable for use with tolerance-compensating contact structures, the connector housing may have at least one section whose material is more flexible than the material of the rest of the connector housing. In other words, the connector housing may be made of a flexible material in sections. A rubber material, for example, can be considered as a flexible material.

In one embodiment, the first and/or second housing sections may each be made entirely of a flexible material, or the first and/or second housing sections may only have a section made of a flexible material.

In order to fix the position of the connector housing at least relative to a busbar, the first housing section may be configured to be fixed to a busbar. The housing section may alternatively or cumulatively be configured to be fixed to the contact structure. The fixed connection can be understood to mean that, in a state connected to the busbar and/or contact structure, at least the section of the connector housing connected to the busbar and/or contact structure is immovable relative to the busbar or contact structure, in particular rigid and/or connected to it in a manner that transmits movement.

The connector housing may have a collar that is adapted to surround the busbar at least in sections and/or to be connected to the busbar in a force-fitting, material-locking and/or form-fitting manner. In particular, the collar may firmly grip the busbar.

In order to prevent incorrect insertion and thus damage to the connector housing, the connector housing may have at least one alignment element arranged at the second access opening, wherein the at least one alignment element protrudes away from the receptacle. The alignment element may be designed to align the connector housing relative to another connector housing. The at least one alignment element may be designed to engage with at least one alignment element of the other connector housing that is designed to be complementary to this at least one alignment element.

In a simple design, the at least one alignment element may have the shape of a fin, a rib or a plate. Similarly, the at least one alignment element may have a guide groove or a guide slot that is designed to be complementary to the fin, rib or plate. The at least one alignment element may have a guide funnel that opens into the guide groove or the guide slot. The funnel may have at least one insertion bevel.

In order to make the connector housing at least on the second housing section touch-protected, in particular inaccessible to human fingers or test fingers, the second housing section may have an electrically non-conductive touch protection profile which divides the second access opening into a plurality of slots arranged next to one another. The slots may together form the second access opening.

The touch protection profile is designed in such a way that the receptacle is inaccessible to a human finger and to a UL or VDE test finger through the slots, but is accessible to contacts of the contact structure. This prevents human fingers or the above-mentioned test fingers from coming into contact with current-carrying components in the receptacle, while the busbar can be electrically contacted by the contacts of the contact structure.

In a structurally simple and robust design, the touch protection profile can have a plurality of touch protection ribs arranged next to each other, wherein each of the slots is formed between adjacent touch protection ribs.

Preferably, the touch protection ribs and/or the slots are arranged parallel to each other and, in particular, equidistant. The touch protection ribs and/or the slots may be arranged in a comb-like pattern.

Center planes spanned by the touch protection ribs may be arranged orthogonally to a center plane spanned by the receptacle. The center plane of the receptacle may run parallel to the flat sides of the receptacle and/or along a longitudinal axis of the receptacle.

The width of the slots may be approximately 2 mm, for example, and the width of the touch protection ribs may be approximately 1 mm. The width of the slots or touch protection ribs may be measured along a stacking direction along which the slots and/or touch protection ribs are arranged parallel to each other. The stacking direction may extend along the first axis, for example.

The height of the slots and/or the touch protection ribs may correspond to a height specified by the UL or VDE test finger. In further embodiments, the height of the slots and/or the touch protection ribs may exceed the height specified by the UL or VDE test finger by approximately 2 mm. For example, the height of the touch protection ribs may be between approximately 5 mm and approximately 9 mm. The height may be measured orthogonally to the center plane of the connector housing receptacle.

In order to simplify the insertion of the connector housing into other components, such as another connector housing, the touch protection profile may have at least one insertion bevel pointing away from the receptacle. Preferably, the connector housing has two insertion bevels that taper towards the center plane of the receptacle.

At least one, but preferably all, of the touch protection ribs may taper away from the receptacle according to one embodiment. For this purpose, the at least one tapered touch protection rib may have at least one, preferably two or more, tapered chamfers on at least one side facing away from the receptacle.

The at least one insertion bevel of the touch protection profile may be formed by bevels of the touch protection ribs. The bevels of the touch protection ribs may lie in a common plane and, in particular, may be identically shaped.

The at least one alignment element may protrude further away from the receptacle than the touch protection ribs. At least one section of the at least one alignment element may be formed by one of the touch protection ribs or may merge into one of the touch protection ribs. The at least one alignment element may correspond to a design of a touch protection rib that has no bevel.

To prevent a human finger from entering the receptacle via the second access opening, at least at the second access opening, a plurality of inwardly projecting touch protection bars may be arranged. Preferably, the touch protection bars are arranged parallel, in particular equidistantly.

The touch protection bars may form or surround a busbar opening through which a busbar can protrude. Gaps formed between two adjacent touch protection bars may open into the receptacle.

The touch protection bars are designed in such a way that the receptacle is inaccessible through the second access opening for a human finger and for UL and/or VDE test fingers.

In one embodiment, a top side and a bottom side of the connector housing opposite the top side can each have a row of touch protection bars. Preferably, each touch protection bar on the top side is opposite a touch protection bar on the bottom side. The number of touch protection bars on the top side may correspond to the number of touch protection bars on the bottom side. Touch protection bars on the top and bottom sides that are opposite each other may be aligned.

Touch protection bars arranged on the top side may protrude towards the bottom side, and touch protection bars arranged on the bottom side may protrude towards the top side. Preferably, the touch protection bars on the top side and/or bottom side are of equal length or protrude equally far inwards.

In order to simplify the insertion of other components into the connector housing, the touch protection bars, on their sides facing away from the first access opening, may taper away from the first access opening. The touch protection bars may each have at least one chamfer which points away from the first access opening, in particular in its normal direction. Preferably, each touch protection bar has at least two chamfers which taper pointedly away from the first access opening.

In order to ensure that the insertion of other components into the connector housing is not blocked by the contact structure, the connector housing may, according to a further embodiment, have positioning elements arranged parallel to each other, which are designed to align contacts of the contact structure relative to the touch protection bars. Alternatively or cumulatively, the positioning elements may be designed to align the busbar relative to the touch protection bars.

The positioning elements may be designed to align the contacts of the contact structure at a pre-determined distance. The positioning elements may be arranged in parallel, in particular equidistantly.

A pitch of the touch protection bars, by which the adjacent touch protection bars are spaced apart from each other, can correspond to a pitch of the positioning elements, by which the adjacent positioning elements are spaced apart from each other.

The positioning elements can align the contacts of the contact structure so that they overlap with the touch protection bars, in particular along a longitudinal direction of the receptacle of the connector housing, in particular so that they are completely aligned. The positioning elements can extend along the longitudinal direction of the receptacle and/or a longitudinal direction of the first housing section and/or a longitudinal direction of the second housing section.

According to one embodiment, the positioning elements can be arranged on the second housing section.

The positioning elements may, on their sides facing the second access opening, taper along a direction pointing from the first to the second access opening. The positioning elements may have at least one, but preferably two, chamfers that run towards each other. In these designs, the insertion of the positioning elements between the contacts of the contact structure or the insertion of the contacts of the contact structure between the positioning elements is simplified, in particular by preventing the positioning elements from becoming entangled with the contacts.

In another embodiment, a housing assembly is provided with a first connector housing and a second connector housing that can be connected to the first connector housing, wherein the touch protection bars of the second connector housing can be inserted at least in sections into the slots of the touch protection profile of the first connector housing.

The housing assembly is suitable for tolerance-compensating plug connections, as the first and second connector housings each have movable housing sections and the first connector housing is also movable, in particular pivotable, relative to the second connector housing.

In this embodiment, the first connector housing may have the touch protection profile, while the second connector housing may be provided with the touch protection bars.

Preferably, in each slot of the touch protection profile of the first connector housing exactly one touch protection bar of the second connector housing is received at least partially.

In one embodiment, the touch protection profile may comprise a plurality of touch protection ribs arranged next to each other, and the touch protection ribs of the touch protection profile may be arranged in a comb-like manner with the touch protection bars. The touch protection ribs and touch protection bars may always be arranged alternately next to each other.

In another embodiment, a touch-protected contact assembly is provided with a housing assembly and with a contact structure received at least in sections in the receptacle of the second connector housing, which contact structure can be plugged onto a first and a second busbar and is movable relative to the first and/or second busbar and is configured to electrically connect the first busbar to the second busbar. The contact structure is designed to compensate for positional tolerances between the first and second busbars. The housing assembly is suitable for compensating for positional tolerances due to the mobility of the housing sections of both connector housings relative to each other and due to the relative mobility of the two connector housings relative to each other. At the same time, human fingers are prevented from coming into contact with the current-carrying components arranged in the housing assembly.

The contact structure may have at least one contact, but preferably several contacts.

There are virtually no limits to the design of the contact structure. For example, the contacts of the contact structure can be designed as cables, contact bridges or terminals. Furthermore, the contact structure can have at least one electrical connector that can be connected to the first and/or second busbar.

Further examples of possible contact structures are disclosed in German patent application DE 10 2024 136 289.8.

In a further embodiment, a touch-protected plug connection is provided with a contact assembly, with the first busbar, which is inserted at least in sections into the receptacle of the first connector housing, with the second busbar, which is inserted at least in sections into the receptacle of the second connector housing, wherein the contact structure is plugged onto the first and second busbar and electrically connects them to each other, wherein the touch protection bars of the second connector housing are arranged at least in sections in the slots of the touch protection profile of the first connector housing, and wherein at least one contact of the contact structure electrically contacts the first busbar through the slots of the touch protection profile.

The plug connection is capable of compensating for tolerances between the first and second busbar. Due to the mobility of the connector housings relative to each other and the mobility of the housing sections of each connector housing relative to each other, the housing assembly is capable of allowing the tolerance-compensating movements.

In order to define the position of the busbars at least relative to the respective first housing section and to securely fasten the busbars to the respective connector housing, the first housing section of the first connector housing can be fixed to the first busbar and/or the first housing section of the second connector housing can be fixed to the second busbar. The first housing sections can be fixed immovably or rigidly to their respective busbars. The fixing can be positive, for example with latching elements, and/or frictional, for example by pressing, and/or material-locking, for example by gluing or welding.

Preferably, only the second housing section of the first connector housing is movable relative to the first busbar and/or only the second housing section of the second connector housing is movable relative to the second busbar.

The invention is explained in more detail below with reference to the accompanying figures. Individual features present in the following embodiment may be omitted if, according to the above embodiments, the technical effect associated with this feature is not relevant. Conversely, a feature described above but not present in an exemplary embodiment below may be added to the exemplary embodiment if the technical effect associated with this feature is important for a particular application.

### BRIEF DESCRIPTION OF THE DRAWINGS

In the following, the same reference numerals are used for elements that correspond to each other in terms of structure and/or function. Shown:

FIG. 1 a schematic perspective view of a connector housing according to one possible embodiment;

FIG. 2 a schematic sectional view of the connector housing from FIG. 1;

FIG. 3 a schematic sectional view of a connector housing according to another possible embodiment;

FIG. 4 a schematic perspective view of a connector housing according to another possible embodiment;

FIG. 5 a schematic perspective view of a plug connection according to one possible embodiment;

FIG. 6 a schematic sectional view of the plug connection from FIG. 5; and

FIG. 7 a schematic perspective view of the plug connection from FIG. 6, without the second housing section of the second connector housing.

### DETAILED DESCRIPTION OF THE INVENTION

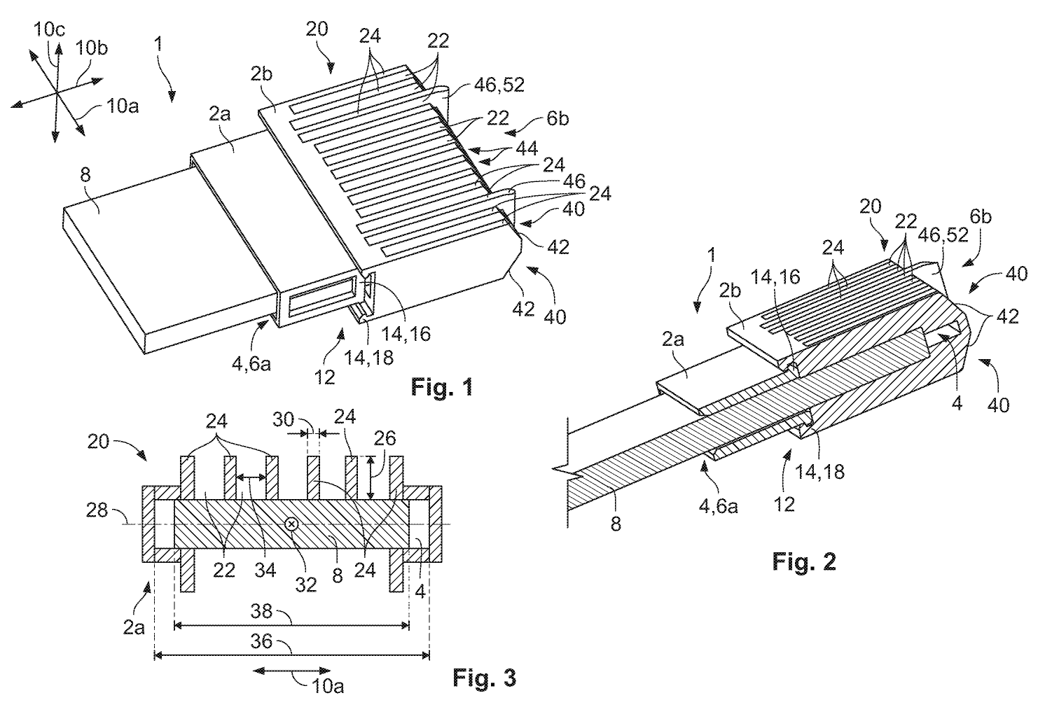

In the following, a connector housing according to one possible embodiment is described purely by way of example with reference to FIGS. 1-3.

The connector housing 1 has a first housing section 2a and a second housing section 2b. As can be clearly seen in FIG. 2, the connector housing 1 comprises a receptacle 4 which extends from a first access opening 6a to a second access opening 6b. The first access opening 6a is located in the first housing section 2a and the second access opening 6b is located in the second housing section 2b. In the embodiment shown, a busbar 8 is inserted into the connector housing 1 as an example. The busbar 8 is accommodated in the receptacle 4 of the connector housing 1 and can protrude from the connector housing 1 at the first access opening 6a.

The first housing section 2a is movable relative to the second housing section 2b. In the embodiment shown, the first housing section 2a is movable relative to the second housing section 2b along a first axis 10a. In other embodiments, the first housing section 2a can be movable relative to the second housing section 2b alternatively or cumulatively along a second axis 10b and/or a third axis 10c, wherein the first, second and third axes 10a, 10b, 10c are each oriented perpendicular to each other. In yet other embodiments, the first housing section 2a can be rotatable, in particular pivotable, relative to the second housing section 2b alternatively or cumulatively about the first axis 10a and/or the second axis 10b and/or the third axis 10c.

In the embodiment shown in FIGS. 1 and 2, the displacement of the first housing section 2a relative to the second housing section 2b along the first axis 10a can be achieved by a form-fit assembly 12. In the embodiment shown, the form-fit assembly 12 may comprise form-fit elements 14, whereby at least one of these form-fit elements 14 may be arranged on each of the first and second housing sections 2a, 2b. In the embodiment shown in FIGS. 1 and 2, the form-fit element 14 of the first housing section 2a can be designed as a protrusion 16, and the form-fit element 14 on the second housing section 2b can be designed as a groove 18 complementary to the protrusion 16. The form-fit assembly 12 allows the first housing section 2a to be connected to the second housing section 2b. Of course, the form-fit assembly 12 can also be designed differently, so that, for example, at least one of the form-fit elements 14 is designed as a latching means.

In the design shown in FIGS. 1 and 2, the first housing section 2a can be fixed to the busbar 8. Fixing can be understood to mean that the first housing section 2a is rigidly connected to the busbar 8 and cannot move relative to the busbar 8. The fixing of the first housing section 2a to the busbar 8 can be achieved by a form-fitting connection, a force-fitting connection, a material-fitting connection or a combination of at least two of the aforementioned connection types. Since, in the embodiment shown in FIGS. 1 and 2, the first housing section 2a is fixedly connected to the busbar 8 but is mounted so as to be displaceable relative to the second housing section 2b, the second housing section 2b can be aligned relative to the busbar 8. In the embodiment shown in FIGS. 1 and 2, the second housing section 2b may have an electrically non-conductive touch protection profile 20 that prevents the second access opening 6 from being opened.

In the embodiment shown in FIGS. 1 and 2, the second housing section 2b may have an electrically non-conductive touch protection profile 20 that divides the second access opening 6b into a plurality of slots 22 arranged next to each other. In this embodiment, the second access opening 6b can therefore be formed by or correspond to the plurality of slots 22. The touch protection profile 20 can have a plurality of touch protection ribs 24 arranged next to each other, with one of the slots 22 being formed between each adjacent touch protection rib 24. The touch protection ribs 24 are arranged so close together and the slots 22 are so narrow that human fingers cannot penetrate the receptacle 4 or come into contact with the busbar 8 or other current-carrying components inserted into the receptacle 4.

The touch protection ribs 24 can be arranged parallel to each other and, in particular, equidistant from each other, as shown in the embodiments depicted in FIGS. 1 and 2. As can be seen from the schematic sectional view in FIG. 3 of a touch protection profile 20 according to a further embodiment, the touch protection ribs 24 can each have a height 26 measured orthogonally to a center plane 28 of the receptacle 4 of the connector housing 1. The height 26 of the touch protection ribs 24 may, for example, be between approximately 5 mm and approximately 9 mm. As can also be seen from FIG. 3, the touch protection ribs 24 may each have a width 30 which can be measured along the center plane 28 of the receptacle 4 and perpendicular to a longitudinal direction 32 of the receptacle 4. The width 30 of the touch protection ribs 24 may, for example, be approximately 1 mm. A width 34 of the slots 22, which may also be measured along the center plane 28 of the receptacle 4 and perpendicular to the longitudinal direction 32 of the receptacle 4, may, for example, be approximately 2 mm. In addition, a width 36 of the receptacle 4 may be greater than a width 38 of the busbar 8 in order to realize the displacement of the second housing section 2a relative to the busbar 4 along the first axis 10a.

FIGS. 1 and 2 further show that the connector housing 1 may have at least one insertion bevel 40 pointing away from the receptacle 4. In the present embodiment, the connector housing 1 may be provided with two insertion bevels 40, which may converge towards each other. The insertion bevels 40 can be formed by bevels 42 of the individual touch protection ribs 24 which converge towards each other. The individual bevels 42 do not necessarily have to be additionally provided with chamfers 44 which point away from the receptacle 4.

The connector housing 1 may also have at least one alignment element 46, which may be arranged at the second access opening 6b and may protrude away from the receptacle 4. In the embodiment shown, two alignment elements 46 are provided purely as examples, each of which may be formed by one of the touch protection ribs 24 or may open into one of the touch protection ribs 24. In the embodiment shown in FIGS. 1 and 2, the alignment elements 46 may correspond in particular to a touch protection rib 24 which is not provided with a bevel 42. Of course, in other embodiments, the alignment elements 46 may also be arranged at other locations on the second housing section 2b, in particular not on a touch protection rib 24.

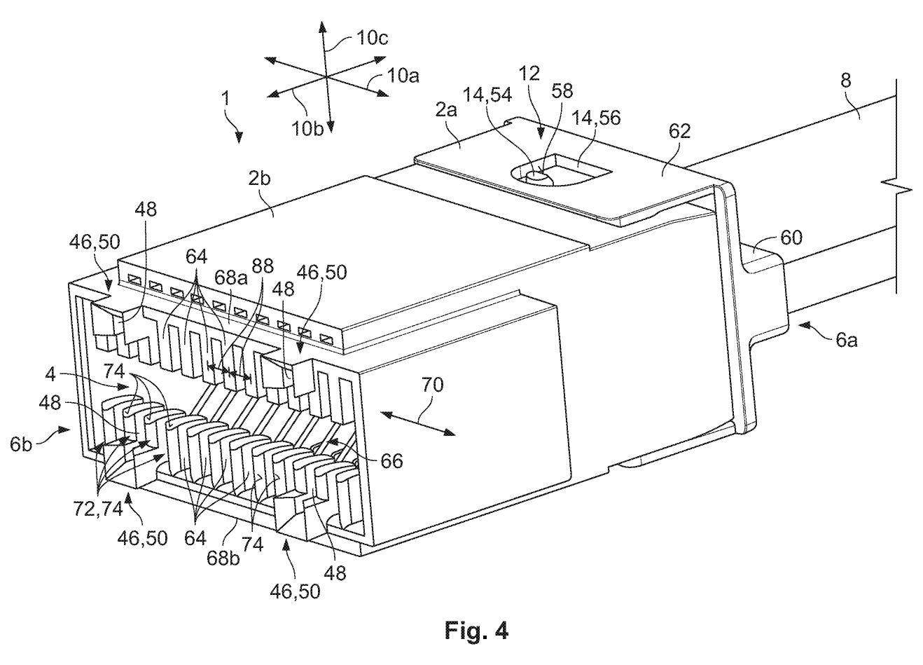

The alignment elements 46 of the connector housing 1 may be designed to align the connector housing 1 relative to another connector housing 1. The other connector housing 1 may also have at least one alignment element 46 for this purpose, which may be designed to be complementary to the alignment elements 46 of the connector housing 1. As shown in FIG. 4, the other connector housing 1 may, for example, have insertion funnels 50 opening into insertion slots 48, into which the alignment elements 46 of the connector housing 1 shown in FIGS. 1 and 2, which are designed as fins 52, can engage. Of course, there are virtually no limits to the design of the alignment elements 46.

FIG. 4 shows a connector housing 1 according to a further advantageous embodiment. The connector housing 1 has a first housing section 2a with the first access opening 6a and a second housing section 2b with the second access opening 6b, with the receptacle 4 extending between the first and second access openings 6a, 6b. The first housing section 6a is movable relative to the second housing section 6b. In the embodiment shown, the first housing section 6a can be rotatable or pivotable relative to the second housing section 6b, in particular about the first axis 10a. Of course, as already explained above, the first housing section 2a, 2b can be displaceable relative to the second housing section 2a, 2b along the first and/or second and/or third axis 10a, 10b, 10c and/or rotatable around the first and/or second and/or third axis 10a, 10b, 10c, in particular pivotable around the first and/or second and/or third axis 10a, 10b, 10c. Of course, combinations of translational and rotational movements of the first relative to the second housing section 2a, 2b may also be possible.

The connector housing 1 shown in FIG. 4 may also have a form-fit assembly 12 by means of which the first and second housing sections 2a, 2b can be or – in this case – are connected in a form-fitting manner. The form-fitting connection may preferably be detachable and re-attachable. The form-fit assembly 12 may comprise a form-fit element 14 arranged on the second housing section 2b, which is shown here purely as an example in the form of a protrusion 54, and a form-fit element 14 arranged on the first housing section 2a, which is shown here as an example in the form of a recess 56. The protrusion 54 may be provided with a chamfer 58 to facilitate the placement or attachment of the first housing section 2a onto the second housing section 2b. In the embodiment shown in FIG. 4, the first housing section 2a can be fixed to the busbar 8. For this purpose, the first housing section 2a can in particular have a collar 60 which surrounds the busbar 8, in particular grips it firmly.

The connector housing 1 may have at least one section 62 whose material is more flexible than the material of the rest of the connector housing 1. In the embodiment shown in FIG. 4, the entire first housing section 2a may consist of such a flexible material or correspond to section 62 made of the flexible material. In this way, the mobility of the first housing section 2a relative to the second housing section 2b can be further increased. Of course, in other embodiments, the second housing section 2b may alternatively or cumulatively have a section 62 made of a flexible material or correspond completely to this section 62. Similarly, only a section of the first housing section 2a and/or only a section of the second housing section 2b may be made of a flexible material. Elastic materials such as rubber are particularly suitable as flexible materials.

As can also be seen from FIG. 4, a plurality of inwardly projecting touch protection bars 64 may be arranged at the second access opening 6b of the second housing section 2b to prevent human fingers or other objects from entering the receptacle 4. In particular, human fingers can be prevented from coming into contact with a contact structure 66 or busbar 8 accommodated in the receptacle 4.

In the present embodiment, a row of touch protection bars 64 is arranged on a top side 68a and on a bottom side 68b of the second housing section 2b, purely by way of example. The touch protection bars 64 on the top side 68a can protrude in the direction of the touch protection bars 64 on the bottom side 68b, while the touch protection bars 64 on the bottom side 68b can protrude in the direction of the touch protection bars 64 on the top side 68a. The touch protection bars 64 on the top side 68a do not have to be opposite one of the touch protection bars 64 on the bottom side 68b, as shown in the embodiment in FIG. 4, and in particular do not have to be aligned with it. For example, the touch protection bars 64 on the bottom side 68b and the top side 68a may be offset along a stacking direction 70 along which the touch protection bars 64 may lie next to each other.

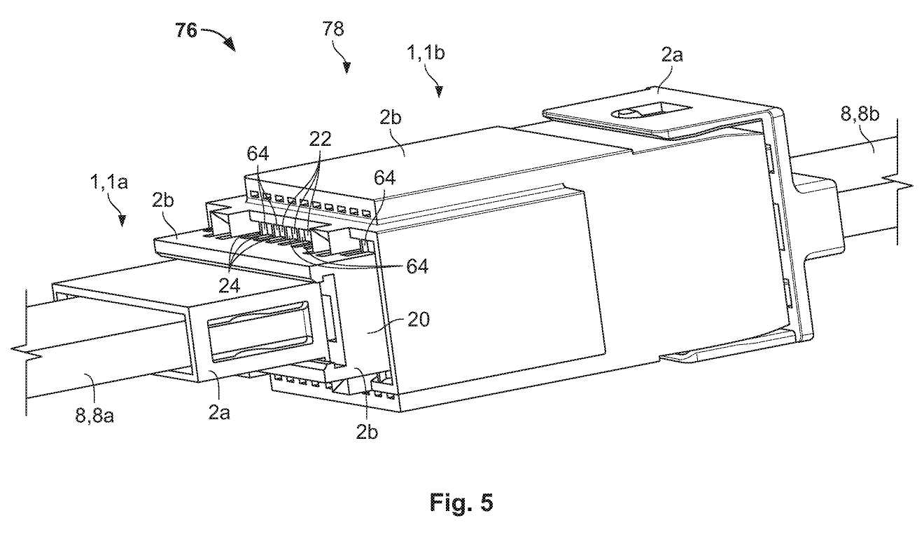

The touch protection bars 64 may, on their sides 72 facing away from the first access opening 6a, taper away from the first access opening 6a. The touch protection bars 64 may be provided with at least one chamfer 74, but preferably with several chamfers 74. The tapered or chamfered touch protection bars 64 can facilitate the insertion of other elements into the connector housing 1. As can be seen from FIG. 5, such an element may correspond, for example, to a further connector housing 1, in particular the connector housing 1 shown in FIGS. 1 and 2.

In the following, a touch-protected plug connection 76 is described purely by way of example with reference to FIGS. 5-7.

The plug connection 76 may comprise a housing assembly 78 with a first connector housing 1, 1a and a second connector housing 1, 1b. The first connector housing 1, 1a may, for example, correspond to the connector housing 1 shown in FIGS. 1 and 2, and the second connector housing 1, 1b may correspond to the connector housing 1 shown in FIG. 4. Of course, the first and/or second connector housings 1, 1a, 1b may alternatively correspond to other designs of the connector housing 1. In the embodiment shown in FIGS. 5-7, the first and second connector housings 1, 1a, 1b are plugged together and the touch protection bars 64 of the second connector housing 1, 1b are each inserted at least in sections into one of the slots 22 of the touch protection profile 20 of the first connector housing 1, 1a. Both the receptacle 4 of the second housing section 2b of the second connector housing 1, 1b and the receptacle 4 of the second housing section 2b of the first connector housing 1a are thus protected against the intrusion of a human finger from outside the housing assembly 78.

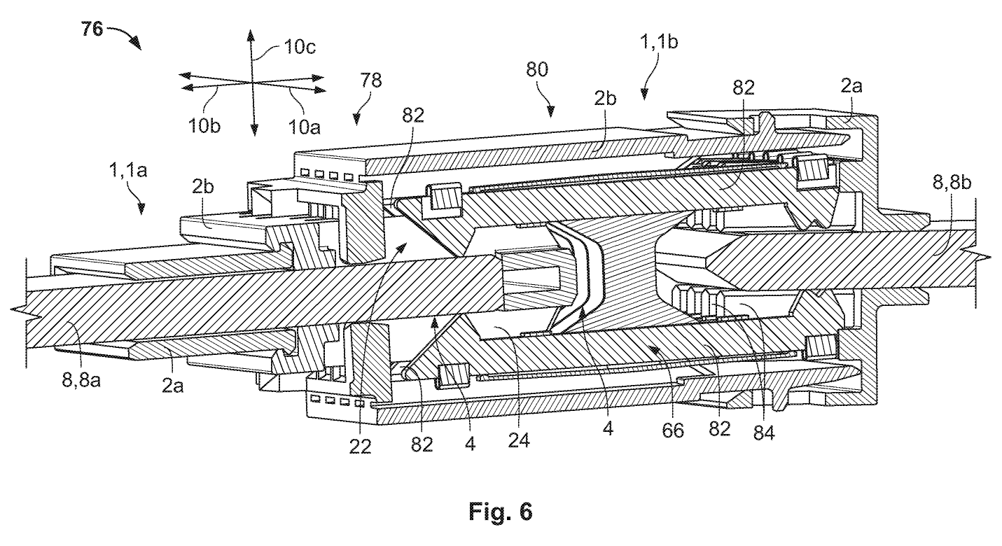

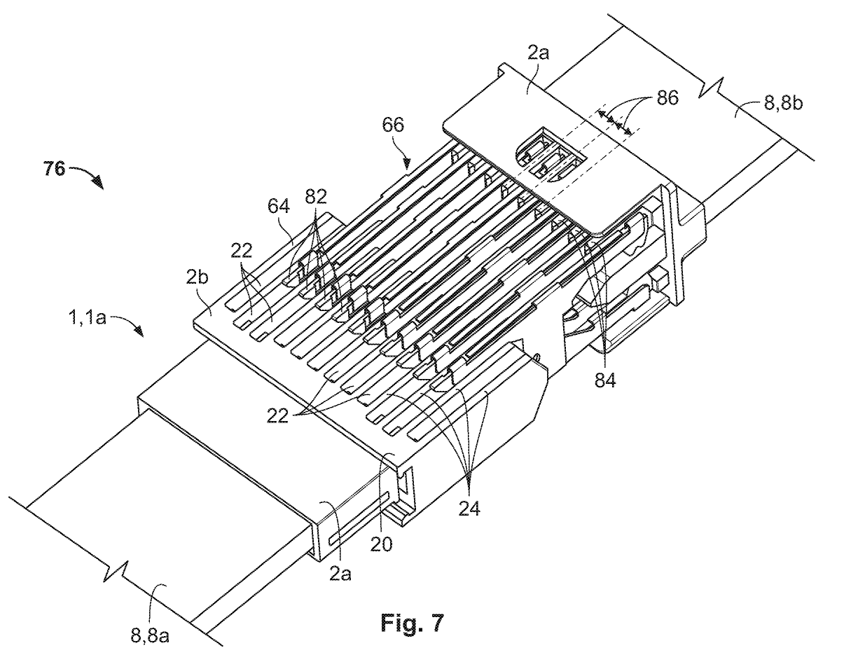

As shown in FIG. 6, the plug connection 76 may have a touch-protected contact assembly 80 with the housing assembly 78. The contact assembly 80 may comprise a contact structure 66 which is received at least in sections in the receptacle 4 of the second connector housing 1, 1b and which, in the embodiment shown in FIGS. 6 and 7, comprises a plurality of contacts 82 arranged parallel to one another, purely by way of example. The contacts 82 may, for example, be designed as flat contact bridges. In the embodiment shown in FIG. 6, the contacts 82 of the contact structure 66 may be plugged onto a first busbar 8a, which is inserted at least in sections into the receptacle 4 of the first connector housing 1, 1b 1a, and onto a second busbar 8b, which is inserted at least in sections into the receptacle 4 of the second connector housing 1, 1b. In this way, the contact structure 66 can electrically connect the first and second busbars 8, 8a, 8b to each other.

The contact structure 66 can be movable relative to the first and/or second busbar 8, 8a, 8b in order to compensate for tolerances or relative movements between the first and second busbar 8, 8a, 8b. In doing so, the contact structure 66 can, for example, compensate for translational relative movements along the first and/or second and/or third axis 10a, 10b, 10c. Similarly, rotational movements about the first and/or second and/or third axis 10a, 10b, 10c of the first and/or second busbar 8, 8a, 8b can be compensated for by the contact structure 66.

The design of the contact structure 66 is by no means limited to the design of the contact structure 66 shown in FIGS. 6 and 7. In principle, any contact structure 66 is conceivable which electrically connects the first and second busbars 8, 8a, 8b and which is movable relative to the first and/or second busbar 8, 8a, 8b. For example, in other designs, the contacts 82 of the contact structure 66 may be designed as cables with connection terminals that can be connected to the first or second busbar. In yet other designs, the contacts 82 may be designed as tabs, terminals or electrical plugs. Of course, in some designs, the contact structure 80 may also have only a single contact 82.

In the plug connection 76 shown in FIGS. 5-7, the touch protection bars 64 of the second connector housing 1, 1b can be arranged at least in sections in the slots 22 of the touch protection profile 20 of the first connector housing 1, 1a. As can be seen particularly well in FIG. 6, the contacts 82 of the contact structure 66 can contact the first busbar 8, 8a through the slots 22 of the touch protection profile 20 of the first connector housing 1, 1a. FIG. 7 shows that each contact 82 is preferably arranged in a slot 22 of the touch protection profile 20, so that the contacts 82 and the touch protection ribs 24 of the touch protection profile 20 are always arranged alternately next to each other. The contacts 82 and touch protection ribs 24 can in particular interlock with each other. In other embodiments, it is of course also conceivable that two or more contacts 82 of the contact structure 66 are arranged in each slot 22 and contact the first contact bridge 8, 8a through this slot 22. Nevertheless, it is of course also possible that some slots 22 do not accommodate any contact 82 at all.

In order to align the contacts 82 of the contact structure 66 relative to the touch protection bars 64, the second connector housing 1, 1b may have positioning elements 84 which are preferably arranged parallel to each other. In the embodiment shown, the positioning elements 84 may be located on the first housing section 2a of the second connector housing 1, 1b. As can be clearly seen in FIG. 7, the positioning elements 84 can align the contacts in such a way that, when the first busbar 8 provided with the first connector housing 1, 1a is inserted, 8a equipped with the first connector housing 1, 1a, each touch protection rib 24 of the touch protection profile 20 can enter the contact structure 66, in particular between adjacent contacts 82 of the contact structure 66. Similarly, each contact 82 of the contact structure 66 can engage in a slot 22 of the touch protection profile 20 and contact the first busbar 8, 8a through this slot. A pitch 86 of the positioning elements 84, by which the adjacent positioning elements 84 are spaced apart from each other, can preferably correspond to a pitch 88 (see FIG. 4) of the touch protection bars 64, by which the adjacent touch protection bars 64 are spaced apart from each other.

Since the first housing section 2a, 2b of the first connector housing 1, 1a is movable relative to the second housing section 2a, 2b, the first busbar 8, 8a can still be moved relative to the second busbar 8, 8b even when the touch protection profile 20 is inserted into the receptacle 4 of the second connector housing 1, 1b.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, in the following claims, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Connector housing comprising:
a first housing section and a second housing section,
a receptacle extending from a first access opening to a second access opening, wherein in the receptacle at least one busbar and/or contact structure can be accommodated at least in sections,
wherein the first access opening is arranged in the first housing section and the second access opening is arranged in the second housing section, and
wherein the first housing section is movable relative to the second housing section.

2. Connector housing according to claim 1,
wherein the connector housing has a form-fit assembly, wherein the first and second housing sections can be connected in a formfitting manner.

3. Connector housing according to claim 1,
wherein the connector housing has at least one section whose material is more flexible than the material of the rest of the connector housing.

4. Connector housing according to claim 1,
wherein the first housing section is configured to be fixed to a busbar.

5. Connector housing according to claim 1,
wherein the connector housing has at least one alignment element arranged at the second access opening, wherein the at least one alignment element protrudes away from the receptacle.

6. Connector housing according to claim 1,
wherein the second housing section has an electrically nonconductive touch protection profile which divides the second access opening into a plurality of slots arranged next to one another.

7. Connector housing according to claim 6,
wherein the touch protection profile has a plurality of touch protection ribs arranged next to each other, wherein each of the slots is formed between adjacent touch protection ribs.

8. Connector housing according to claim 6,
wherein the touch protection profile has at least one insertion bevel pointing away from the receptacle.

9. Connector housing according to claim 1,
wherein, at least at the second access opening, a plurality of inwardly projecting touch protection bars are arranged.

10. Connector housing according to claim 9,
wherein, on their sides facing away from the first access opening, the touch protection bars taper away from the first access opening.

11. Connector housing according to claim 9,
with positioning elements arranged parallel to each other, which are designed to align contacts of the contact structure relative to the touch protection bars.

12. Housing assembly comprising:
a first connector housing including a first housing section and a second housing section and a receptacle extending from a first access opening to a second access opening, wherein in the receptacle at least one busbar and/or contact structure can be accommodated at least in sections, wherein the first access opening is arranged in the first housing section and the second access opening is arranged in the second housing section, and wherein the first housing section is movable relative to the second housing section, wherein the second housing section has an electrically nonconductive touch protection profile which divides the second access opening into a plurality of slots arranged next to one another;
and a second connector housing configured to be connected to the first connector housing, the second connector housing including a third housing section and a fourth housing section and a receptacle extending from a third access opening to a fourth access opening, wherein in the receptacle at least one busbar and/or contact structure can be accommodated at least in sections, wherein the third access opening is arranged in the third housing section and the fourth access opening is arranged in the fourth housing section, and wherein the third housing section is movable relative to the fourth housing section, wherein the fourth housing section has an electrically nonconductive touch protection profile which divides the fourth access opening into a plurality of slots arranged next to one another, wherein, at least at the fourth access opening, a plurality of inwardly projecting touch protection bars are arranged,
wherein the touch protection bars of the second connector housing can be inserted at least in sections into the slots of the touch protection profile of the first connector housing.

13. Housing assembly according to claim 12,
wherein the first connector housing has a form-fit assembly, wherein the first and second housing sections can be connected in a formfitting manner.

14. Housing assembly according to claim 12,
wherein the first connector housing has at least one section whose material is more flexible than the material of the rest of the first connector housing.

15. Housing assembly according to claim 12,
wherein the first housing section is configured to be fixed to a busbar.

16. Housing assembly according to claim 12,
wherein the first connector housing has at least one alignment element arranged at the second access opening, wherein the at least one alignment element protrudes away from the receptacle.

17. Touch-protected plug connection comprising:
a housing assembly including a first connector housing and a second connector housing configured to be connected to the first connector housing, the first connector housing including a first housing section and a second housing section and a receptacle extending from a first access opening to a second access opening, wherein in the receptacle at least one busbar and/or contact structure can be accommodated at least in sections, wherein the first access opening is arranged in the first housing section and the second access opening is arranged in the second housing section, and wherein the first housing section is movable relative to the second housing section, wherein the second housing section has an electrically nonconductive touch protection profile which divides the second access opening into a plurality of slots arranged next to one another, the second connector housing including a third housing section and a fourth housing section and a receptacle extending from a third access opening to a fourth access opening, wherein in the receptacle at least one busbar and/or contact structure can be accommodated at least in sections, wherein the third access opening is arranged in the third housing section and the fourth access opening is arranged in the fourth housing section, and wherein the third housing section is movable relative to the fourth housing section, wherein the fourth housing section has an electrically nonconductive touch protection profile which divides the fourth access opening into a plurality of slots arranged next to one another, wherein, at least at the fourth access opening, a plurality of inwardly projecting touch protection bars are arranged, wherein the touch protection bars of the second connector housing can be inserted at least in sections into the slots of the touch protection profile of the first connector housing;
a touch-protected contact assembly including a contact structure received at least in sections in the receptacle of the second connector housing, the contact structure configured to be plugged onto a first busbar and a second busbar, the contact structure being movable relative to the first busbar and/or the second busbar and is configured to electrically connect the first busbar to the second busbar,
wherein the first busbar, which is inserted at least in sections into the receptacle of the first connector housing,
wherein the second busbar, which is inserted at least in sections into the receptacle of the second connector housing,
wherein the contact structure is plugged onto the first and second busbars and electrically connects the first and second busbars to each other,
wherein the touch protection bars of the second connector housing are arranged at least in sections in the slots of the touch protection profile of the first connector housing,
and wherein at least one contact of the contact structure electrically contacts the first busbar through the slots of the touch protection profile.

18. Plug connection according to claim 17,
wherein the first housing section of the first connector housing is fixed to the first busbar and/or wherein the third housing section of the second connector housing is fixed to the second busbar.

19. Plug connection according to claim 17,
wherein the first connector housing has a form-fit assembly, wherein the first and second housing sections can be connected in a formfitting manner.

20. Plug connection according to claim 17,
wherein the first connector housing has at least one section whose material is more flexible than the material of the rest of the first connector housing.
